(19) United States
(12) Patent Application Publication
(10) Pub. No.: US 2020/0001731 A1
(43) Pub. Date: Jan. 2, 2020

(54) Continuous recharging of driverless electric vehicles without human inter action.

(71) Applicant: Sten R. Gerfast, Mendota Heights, MN (US)

(72) Inventor: Sten R. Gerfast, Mendota Heights, MN (US)

(21) Appl. No.: 15/732,844

(22) Filed: Jan. 3, 2018

(51) Int. Cl. B60L 53/14; B60L 53/30; G05D 1/02

(52) U.S. Cl. CPC B60L 53/14; B60L 53/30; G05D 2201/0213; G05D 2201/0207; G05D 1/0278

(57) ABSTRACT

This invention is for an inexpensive and cost-effective way to patrol and prevent un-authorized personnel from entering or crossing a special one-way roadway. By having continuous surveillance, with the patrol-vehicles having photo equipment, infra-red equipment, radio equipment for contacting proper authority, and having a siren equipped vehicle, it is unlikely for un-authorized personnel from entering or crossing the one-way roadway.

The road way is having a left and right fence, preferably made with transparent panels, allowing for visual and infrared surveillance. This surveillance allows for instant detection of any un-authorized person or equipment,

The preferred patrol is with a vehicle that is electric and driverless. Signage stating of an addition of an electrified wire, similar to “animal-prevention-fence” prevents personnel from entering the roadway.

### DESCRIPTION OF THE INVENTION

This invention is for an inexpensive way to patrol and prevent un-authorized personnel from entering or crossing a one-way roadway.

By having continuous surveillance, with patrol-vehicles doing the surveillance, and with the vehicle having photo equipment, infra-red equipment, radio equipment for contacting proper authority and a siren equipped vehicle, it is unlikely for un-authorized personnel from entering or crossing this one-way roadway.

The preferred patrol is with a vehicle that is electric and driverless.

The preferred charging of the electric patrol vehicle is for a patrol vehicle to have the capability for electrical charging automatically during its automatic driving along the one-way road, without human inter action.

The preferred system is to have the patrol vehicles spaced at a correct interval, with all the patrol vehicles first run forward, and then the patrol vehicles all backing up. This would prevent the necessity of human inter action at the end of the road way.

It is likely that patrol vehicles would drive at a low to medium speed, making for low wear and tear on the vehicles. An electric vehicle is, because of its direct drive, much easier to drive in reverse.

In addition, the low to medium speed is not using much battery power.

To further prevent un-authorized personnel from entering or crossing the one-way roadway, an electrified wire similar to “animal-prevention-fence” can be assembled on top of the fence.

This “without human inter action” type of patrolling, using a vehicle that is electric and driverless,

with the availability for charging the vehicle automatically, is the least costly type of patrolling any industrial installation, or other installations.

### BRIEF DESCRIPTION OF THE DRAWINGS

FIG. 1 is showing a driverless electric vehicle traveling on a one-way roadway doing surveillance, in between a left wall, and a right wall, also having a service road on the far left. A corrugated transparent left and right fence wall, are secured in the road bed, Shown is also an electric vehicle having an attached receiving contact for charging the electric vehicle.

FIG. 2 is showing charging contacts, one male type and one female type which can charge the electric vehicle automatically during its running. It is showing the primary charging contacts on the right attached to a fence along the roadway, and the receiving contacts, shown on the left, that will be attached to the vehicle.

FIG. 3 is showing a roadway with a number of patrolling vehicles spaced at the appropriate spacing between vehicles. It is also showing an entering point, having a gate. and an exit point from the one-way roadway, also having a gate.

### DETAILED DESCRIPTION OF THE DRAWINGS

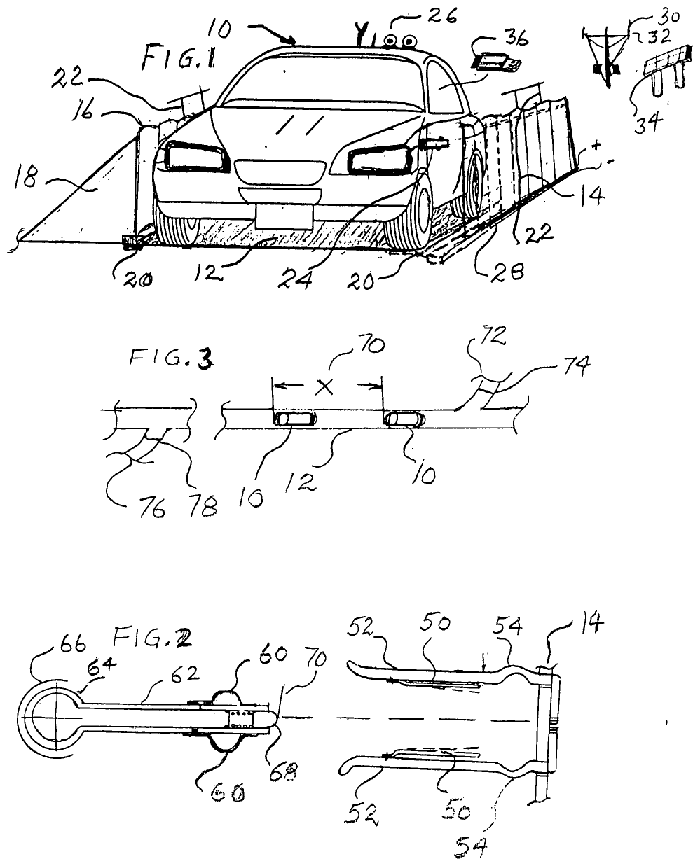

FIG. 1 is showing a driverless electric vehicle 10 traveling on a one-way roadway 12 doing surveillance,

in between a left wall 14 and a right wall 16. A service road 18 on the far left. A corrugated transparent left 14 and right fence wall 16, is secured in the road bed 20, Electrical pulses from a pulsed electrified wire 22 similar to “animal-prevention-fence”, is assembled on top of the fence 14 and 16, with appropriate markings.

Shown is also the electric vehicle 10 having an attached receiving contact 24 for charging the electric vehicle, during its running.

The two corrugated fence walls 14 and 16, mounted in the road bed, are secured in concrete 20.

The electric vehicle has several GPS, optical and magnetic sensors and light and siren devises 26, mounted on the vehicle.

A power cable 28 with plus and minus markings, is running along the fence 14. The power to the cable 28 comes from either a power line 30 with bridge rectifiers 32, or from mounted solar panels 34 not needing any rectifiers. Wireless USB adaptors 36 inside the vehicle provide for a multitude of communications.

FIG. 2 is showing charging contacts, one male type and one female type which can charge the electric vehicle automatically during its running.

It is showing the primary two spring-loaded charging contacts 50 on the right, securely attached to a fence 14 along the roadway 12. The two charging contacts 50 are enclosed in a non-conducting material 52, and has a thin sections 54 for greater flexibility. The two receiving contacts 60, also spring-loaded, are shown on the left, and are attached to a non-conducting tubular part 62, having a spherical end 64, which is having a spheroidal mount 66 in the vehicle. This mounting gives the part 62 the maximum flexibility and automatic adjustment up and down.

It also gives the part 62 the ability to be folded into the vehicles body 10.

A spring-loaded non-conducting part 68 is preventing touching of other parts, but can also have an attachment to a sensor 70 measuring the location of part 50 in relation to part 60.

The part 62 is located in about center of part 52 during operation.

FIG. 3 is showing a roadway 12 with a number of patrolling vehicles 10 spaced at the appropriate spacing X 70 between vehicles, that could be described as a patrolling caravan.

It is also showing an entering point 72 having a gate 74. and an exit point 76 from the one-way roadway 12, also having a gate 78.

The above summary is not intended to describe each described embodiments or every implementation of the present invention.

Figures and the detailed description described herein, is not intended to limit other embodiments, or mechanical constructions.

1. Continuous recharging of driverless electric vehicles, having electrical protruding, receiving contacts, mating with charging contacts located on a roadway fence,
thereby charging the vehicles battery,
without human inter action.

2. Continuous recharging of driverless electric vehicles, having electrical protruding, two receiving contacts mating with charging contacts located on a protected one-way roadway fence, thereby charging the vehicles battery when the vehicle is in motion, without human inter actions

3. Continuous recharging of driverless electric vehicles, having electrical protruding, receiving contacts mating with two, or more, charging contacts located on a protected one-way roadway fence, thereby charging the vehicles battery, and also electronically reporting un-authorized persons in the roadway, all without human inter action.

4. Continuous recharging of driverless electric vehicles according to claim 2, wherein one set of supply contacts is mounted on a fence along the roadway, and charging contacts are mounted on the vehicle, with the charging contacts sliding on the fence contacts, both spring loaded together for good electrical conduction, and both protected from the environment.

5. Continuous recharging of driverless electric vehicles according to claim 1, wherein the vehicle is a surveillance patrol vehicle, having several communication devises, GPS, and lights.

6. Continuous recharging of driverless electric vehicles according to claim 3, wherein the fence is made out of clear, corrugated fiberglass panels, or corrugated steel panels having small openings, to provide for the visibility of un-authorized persons,
and the panels being securely imbedded in concrete.

7. Continuous recharging of driverless electric vehicles according to claim 3, wherein the distance between the vehicle and fence is guided by GPS and wireless USB adaptors.

8. Continuous recharging of driverless electric vehicles according to claim 2 wherein the vehicle is having multiple sensors; photo equipment, infra-red equipment, radio equipment for contacting proper authority, a siren equipped vehicle, all for the detecting of un-authorized persons.

9. Continuous recharging of driverless electric vehicles according to claim 2 wherein, the fence is having a pulsed electrified wire similar to “animal-prevention-fence”, which is assembled on top of the fence.

10. Continuous recharging of driverless electric vehicles according to claim 2 wherein the one-way road-way is having safety signage for the danger of entering, danger of vehicle charge voltage, which can be 440 volts AC, alternating current, or DC, direct current, for charging the vehicles battery.

11. Continuous recharging of driverless electric vehicles according to claim 1 wherein the one-way road-way is having fencing on both side of the roadway, and a service road along the roadway, and safety signage for the danger of entering, and signage for danger of an electrified wire, similar to a “animal-prevention-fence”.

12. Continuous recharging of driverless electric vehicles according to claim 4 wherein the charging contacts does receive electrical power from an AC power line, rectified by bridge rectifiers, or electrical DC power from photo-electric panels.

13. Continuous recharging of driverless electric vehicles according to claim 3 wherein the electronical reporting is achieved with wireless USB adaptors.

14. Continuous recharging of driverless electric vehicles, according to claim 4 wherein, on a protected, one-way roadway, utilizing electric, driver-less, vehicles, having electrical contacts, which automatically, electrically, is charging the vehicles battery, and electronically is reporting all interference, together with reporting any un-authorized persons, with all this reporting and surveillance being done without human inter action.

15. Continuous recharging of driverless electric vehicles according to claim 4 wherein the electrical charging is done during the vehicles motion, and a specified distance from supply contacts and the receiving contacts are determined by software, and the amount of battery charging amount, is also guided by GPS or by soft-ware.

16. Continuous recharging of driverless electric vehicles according to claim 3 wherein the charging contacts and the receiving contacts are using wire-less USB adaptors for control of spring load control between them, and a USB adaptor for optimum battery charge rate, and transmission of other technical information.

17. Continuous recharging of driverless electric vehicles according to claim 2 wherein, instead of the electrical transfer from first to second contacts, that are made by electrical contacts, can be made inductively by having two mating primary and secondary inductors, that inductively is transferring AC power from a primary inductor on the fence, to a secondary inductor in the vehicle, possibly using high frequency, for inductive electrical transfer, during the vehicle's motion.

18. Continuous recharging of driverless electric vehicles according to claim 3 wherein any signal is automatically transferred to an office located at exit 76.

19. Continuous recharging of driverless electric vehicles according to claim 8, wherein the stated equipment will have addition of measuring and signal sources to provide and interact with the listed equipment.

20. Continuous recharging of driverless electric vehicles according to claim 5 wherein the described functions, and the surveillance patrol functions, are done by several interspersed vehicles, and being done continuously every day without any human inter action.
